(19) United States
(12) Patent Application Publication
(10) Pub. No.: US 2010/0045056 A1
(43) Pub. Date: Feb. 25, 2010

(54) Scooper with pusher plate

(76) Inventor: Bart E. Greenhut, South Pasadena, CA (US)

Correspondence Address: LEON D. ROSEN;FREILICH, HORNBAKER & ROSEN, SUITE 1220, 10960 WILSHIRE BOULEVARD, LOS ANGELES, CA, 90024, US

(21) Appl. No.: 12/229,424

(22) Filed: Aug. 22, 2008

(51) Int. Cl. A01K 29/00

(52) U.S. Cl. 294/1.3

(57) ABSTRACT

A scooper apparatus (10) for removing feces (44) from the ground, of the type that includes a scooper (11) with a cardboard closing plate (12) that is moved horizontally to move an open bag end (30) so it receives the feces, the cardboard plate then being moved down to close the bag. The scooper includes a pusher plate (50) to help push feces into the bag. The cardboard plate has an opening (52) that holds a piece of cardboard that can be pushed out to form the pusher plate that is used to prevent feces movement.

### BACKGROUND OF THE INVENTION

My earlier U.S. Pat. No. 4,718,707 describes a disposable scooper for scooping up the feces of a dog into a bag and then closing the bag, which is of low cost so it can be disposed of, and which keeps the hands of the user away from the feces. That scooper includes a cardboard plate, a U-shaped wire, and a bag with an open end. The wire has a horizontal bottom lying a few inches below the bottom of the plate and has opposite wire sides that extend up into the cardboard plate and that hold the bag. The bottom of the bag open end is scraped along the ground to receive feces on the ground, and then the cardboard plate is pushed down to close the bag as the wire opposite sides slide into the cardboard plate. The bag, which is closed and contains feces, is thrown into a garbage can.

When the scooper is used, it is often found that the dog feces is pushed along the ground by the bag open end instead of being scooped into the bag. This is especially true for the feces of small dogs. The feces can be forced into the bag by placing a barrier against the feces as the bag scrapes towards it. However, the dog owner often does not have such a barrier, especially one of low cost so it can be disposed of because a small amount of feces sticks to it. A feces scooper that provided means for forcing feces into the bag, which was always available when the owner was about to scoop up feces, which could be readily disposed of, and which did not add appreciable cost to the scooper, would be of value.

### SUMMARY OF THE INVENTION

In accordance with one embodiment of the present invention, a disposable scooper is provided which is always available to a dog owner when he/she begins to scoop up feces with the scooper, which avoids owner contact with the feces, and which does not add an appreciable cost to the manufacture of the scooper. The scooper is of the type that includes a closer plate, preferably of cardboard, a U-shaped wire, and a bag with an open end held between the bottom of the closer plate and a horizontal portion of the wire. To facilitate moving feces into the bag open end, the closer plate carries a pusher in the form of a small plate with a plane lying adjacent to or coplanar with the plane of the closer plate. The pusher is preferably a piece of cardboard that lies in an opening in the closer plate.

The novel features of the invention are set forth with particularity in the appended claims. The invention will be best understood from the following description when read in conjunction with the accompanying drawings.

### DESCRIPTION OF THE DRAWINGS

FIG. 1 is an isometric view of a scooper apparatus of the invention, shown with the pusher removed and being used to push feces into the bag of the scooper.

FIG. 2 is a front elevation view of the scooper of FIG. 1.

### DESCRIPTION OF THE PREFERRED EMBODIMENTS

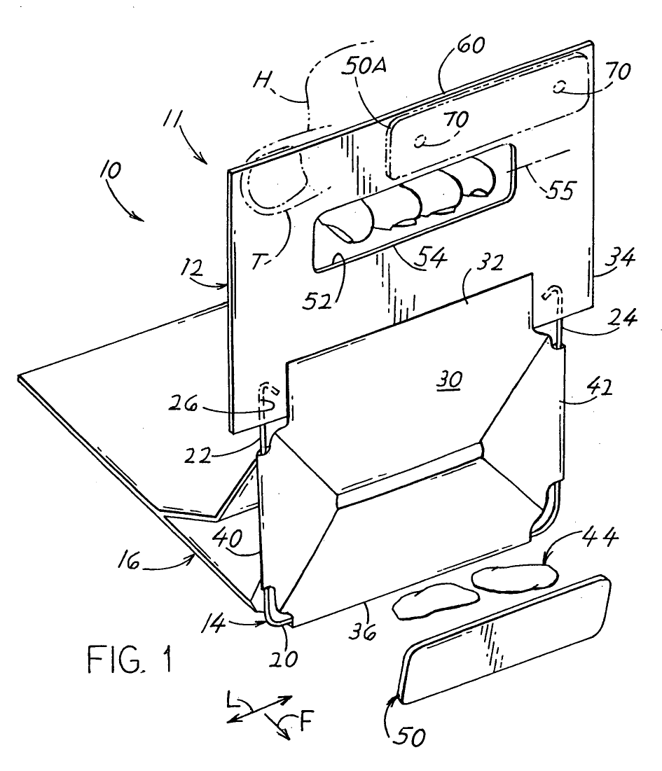

FIG. 1 illustrates a scooper apparatus 10 of the invention which is similar to that of my earlier U.S. Pat. No. 4,718,707, and which includes a scooper 11 with a closer plate 12, a wire 14, and a bag 16. The wire frame or wire 14 is of generally U shape, with a horizontal bottom 20 and vertical opposite sides 22, 24. The closer plate has vertical passages 26, and is preferably formed of corrugated cardboard that is oriented so its passages are vertical, as described in my earlier patent. The wire opposite sides project upward into the closer plate. The bag 16 has a bag end 30 that is initially open and that has vertically opposite bag end parts, including an upper bag part 32 attached to a bottom portion 34 of the closer plate and an opposite lower bag part 36 attached to the wire horizontal bottom 20. The bag also has laterally L opposite parts 40, 42 slidably coupled to the wire opposite sides.

Feces 44 on the ground is picked up by holding the closer plate 12 primarily vertical so the bottom of the bag at 36 lies against the ground near the feces. The closer plate 12 is pressed down against the ground with a small force such as one-half pound. While continuing to press down the closer plate 12, the plate is moved forward F to move the bottom 36 of the bag under the feces and thereby move the feces into the bag. The closer plate is lifted and possibly tilted to drop the feces deep into the bag. The bag lower part 36 is again placed against the ground in the position of FIG. 1 and is then forced down, as with a force of about 3 pounds, so the wire opposite sides 22, 24 slide upward into the plate as the plate is pushed down, to pinch the bag end 30 closed. The scooper is then disposed of as by dropping it into a garbage can. During the operation, a person continues to hold the closer plate with his/her hand H at a constant position relative to the plate until he/she releases the closer plate to drop the scooper into a garbage can.

It often happens that the feces 44 slides along the ground as it is pushed by the bag lower part 36, instead of moving into the bag. This happens most often with feces from small dogs, which do not extend far above the ground. Such feces can be scooped up by pushing it rearward or holding it from moving forward, with a pusher 50. However, a dog owner may forget to bring the pusher or forget where it was stored, when taking the dog for a walk. The owner wants to discard the pusher, which may have feces on it, when the scooper is discarded. The scoopers 11 are manufactured and sold at low prices, and the pusher 50 should be convenient and unlikely to be forgotten when an owner brings a scooper on a dog walk, and should not raise the cost appreciably.

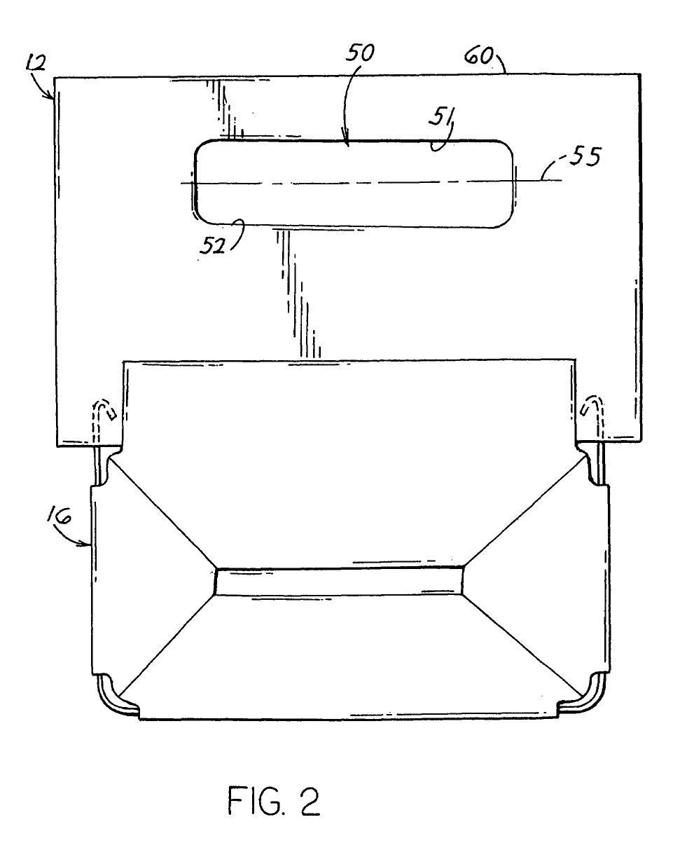

Applicant stores the pusher 50 in an aperture or opening 52 of the closer plate, with a cut 51 (FIG. 2). Where the closer plate is formed of cardboard, the pusher is a piece of cardboard and preferably the cardboard piece left when the aperture was punched out. When the pusher 50 is formed by punching out the aperture 52 from the plate, the pusher can be replaced in the aperture and makes an interference fit with the walls 54 of the aperture. The pusher that is replaced in the aperture is easily removed, as with a pushing force of about 2 pounds. This makes it easy for the owner to remove it because the paper sheets at the front and back of the cardboard do not tear during pusher removal (because they are already cut).

The aperture 52 (FIG. 1) that holds the pusher in an interference fit, is laterally L elongated with a length of at least 2.5 inches and preferably at least 3 inches, and has a height of at least 0.5 inch. This allows a person to place his/her four fingers (other than the thumb) of one hand through the aperture to comfortably hold the closer plate with the thumb T, and allow its easy manipulation. A vertical middle 55 of the aperture is located no more than 3 inches below the plate primarily horizontal top edge 60, to facilitate a person inserting the four fingers through the aperture while the plate top edge 60 lies against the front of the person's palm. The aperture also allows a person to use the closer plate as a handle to conveniently carry the scooper apparatus, especially when it holds feces.

In a scooper apparatus that applicant has constructed, the cardboard had a thickness of 0.12 inch, the pusher 50 was made of the same cardboard as the closer plate, and the pusher 50 and aperture 52 for it each had a length of 3⅛ inch and a vertical width of ¾ inch, with the horizontal centerline 55 of the aperture spaced 1⅜ inch from the plate top edge.

It would be possible to mount a pusher on a face of the closer plate 12, as at 50A in FIG. 1, using a holder 70 that easily released the pusher. With the pusher at 50A it has a plane lying parallel and adjacent to the plane of the closer plate 12 so the apparatus still could be stored in a small space.

Thus, the invention provides a scooper apparatus for scooping up feces from the ground, which includes a pusher that is automatically carried with the scooper. The pusher is planer and lies in substantially the same plane as the closer plate, that is, the pusher lies in the same plane as the closer plate or in a plane spaced from the closer plane by no more than the closer plate thickness. This results in the pusher adding almost no additional thickness to the apparatus. The pusher is preferably formed from the same plate of cardboard as the closer plate and is already separated from the closer plate but lies in an interference fit with the aperture.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A disposable feces scooper for scooping feces off the ground, which includes a closer plate, a wire frame with a horizontal bottom wire part and opposite side wire parts having upper ends slidably held in said closing plate, and a flexible bag with an open end having top and bottom bag open end parts connected respectively to said closing plate and to said bottom wire part, including:
a plate-shaped pusher carried by said closing plate and detachable from the closing plate to push feces into the bag open end.

2. The apparatus described in claim 1 said closing plate has a plane, and wherein:
said pusher is in the form of a plate part with a plate part plane that is parallel to and adjacent to a plane of said closing plate.

3. The scooper described in claim 1 wherein:
said pusher is formed by a portion of said closing plate that is separable from the rest of said closing plate.

4. The scooper described in claim 1 wherein said closing plate is formed of a plate of cardboard, wherein:
said closing plate has a cut that extends in a closed loop and that forms said pusher within said loop.

5. The scooper described in claim 4 wherein:
said pusher is separated from said closing plate but lies in an interference fit in said closed loop cut.

6. The scooper described in claim 4 wherein:
said closing plate has a primarily horizontal upper edge;
said closed loop and said pusher which lies within the loop, each has elongated top and bottom edges and shorter opposite sides, with a horizontal middle of said pusher lying no more than 3 inches from said closing plate upper edge.

7. A disposable feces scooper that includes a cardboard closing plate that has a plane, and a flexible bag coupled to said closing plate and having a bag open end that is closable, wherein:
said closing plate forms an opening and including a pusher that occupies said opening and that can be pushed out of said opening, to use said pusher to push feces into said bag open end.

8. The scooper described in claim 7 wherein:
said pusher is part of said cardboard closing plate.

9. The scooper described in claim 7 wherein:
said closing plate has a top edge and said pusher is horizontally elongated and has a horizontal centerline located less than 3 inches below said closing plate top edge.

10. The scooper described in claim 7 wherein:
said pusher has a horizontal length of at least 2.5 inch, to receive all fingers but the thumb, of a hand.
